(19) United States
(12) Patent Application Publication
(10) Pub. No.: US 2026/0016063 A1
(43) Pub. Date: Jan. 15, 2026

(54) ELECTRIC BRAKE DEVICE

(71) Applicant: ADVICS CO., LTD., Kariya-shi, Aichi-ken (JP)

(72) Inventor: Satoshi HIRATA, Kariya-shi, Aichi-ken (JP)

(73) Assignee: ADVICS CO., LTD., Kariya-shi, Aichi-ken (JP)

(21) Appl. No.: 18/993,242

(22) PCT Filed: Aug. 3, 2023
(86) PCT No.: PCT/JP2023/028378

§ 371 Date: Jan. 10, 2025

(30) Foreign Application Priority Data
Aug. 3, 2022 (JP) 2022-123977

(51) Int. Cl. F16D 65/18; F16D 55/226; F16D 66/00; F16D 121/24; F16D 125/40; F16D 125/48

(52) U.S. Cl. CPC F16D 65/18; F16D 55/226; F16D 2066/005; F16D 2121/24; F16D 2125/40; F16D 2125/48

(57) ABSTRACT

An electric brake device has: a housing that stores a load sensor and holds a rotational section of a linear motion conversion mechanism to be rotatable; and a case assembled to the housing. The case holds a transmission mechanism, which transmits rotary motion of an electric motor, to be rotatable, and the rotational section of the linear motion conversion mechanism mechanically meshes with the transmission mechanism. In such an electric brake device, a first terminal that has an annular shape and is arranged around a rotation axis of the rotational section of the linear motion conversion mechanism is installed on the load sensor, and a second terminal electrically connected to the first terminal by contact with the first terminal is installed in the case.

### TECHNICAL FIELD

The present disclosure relates to an electric brake device.

### BACKGROUND ART

As a caliper-type electric brake device mounted on a vehicle, a device described in PTL 1 has been known. The electric brake device includes an electric motor and a linear motion conversion mechanism. The linear motion conversion mechanism converts rotary motion generated by the electric motor into linear motion. Then, the electric brake device presses a friction member, which interlocks with the linear motion converted by the linear motion conversion mechanism, against a rotary body rotating together with a wheel, and thereby generates a braking force on the wheel. The electric brake device also includes a load sensor that detects a pressing force of the friction member against the rotary body.

### CITATION LIST

### Patent Literature

PTL 1: KR-A-10-2021-0002011

### SUMMARY

### Technical Problem

When components are assembled during manufacture of the electric brake device as described above, it is necessary to align and phase a large number of the components. Then, work required for such alignment and phasing may be a factor that hinders improvement in productivity of the electric brake device.

### Solution to Problem

An electric brake device for solving the above problem transmits rotation of an electric motor to a linear motion conversion mechanism by a transmission mechanism, converts rotary motion transmitted by the transmission mechanism from rotary motion of a rotational section into linear motion of a linear motion section in the linear motion conversion mechanism, presses a friction member that interlocks with the linear motion of the linear motion section against a rotary body that rotates together with a wheel, and thereby generates a braking force on the wheel. In addition, the electric brake device includes: a sensor that detects a pressing load of the friction member against the rotary body and outputs a signal corresponding to the detected pressing load to an output section; a connection section as a portion that electrically connects the output section to a control section controlling the electric brake device; a housing that stores the sensor, the output section, and the linear motion conversion mechanism; and a case that stores the transmission mechanism, the control section, and the connection section. The electric brake device is manufactured by causing the rotational section of the linear motion conversion mechanism and the transmission mechanism to mechanically mesh with each other when the housing and the case are assembled. Furthermore, the rotational section in the electric brake device is arranged to be coaxial with a rotation axis of the transmission mechanism that directly meshes with the rotational section. One of the output section and the connection section has a contacted section that is formed in an annular shape or an arc shape and is arranged around the rotation axis. The other of the output section and the connection section has a contact section that electrically connects the output section and the connection section by contacting the contacted section in a state where the housing and the case are assembled.

The contacted section of the electric brake device is formed in the annular shape or the arc shape that is arranged around the rotation axis. Accordingly, even when a relative rotational phase between the case and the housing around the rotation axis is changed to some extent, the electrical connection between the output section and the connection section is not cut off. In addition, the output section and the connection section are electrically connected by the contact between the contact section and the contacted section. Accordingly, when the case and the housing rotate relative to each other, the output section and the connection section do not interfere with each other. Thus, it is possible to rotate the case and the housing relative to each other about the rotation axis also after the engagement between the rotational section and the transmission mechanism. In this way, in the assembly of the case and the housing, the rotational section and the transmission mechanism can be phased by the relative rotation between the case and the housing. Therefore, the electric brake device has an effect of facilitating assembly work during manufacturing.

### BRIEF DESCRIPTION OF DRAWINGS

FIG. 1 is a view illustrating a cross-sectional structure of an embodiment of an electric brake device and peripheral components thereof.

FIG. 2 is a cross-sectional view of the electric brake device that is taken along line 2-2 in FIG. 1.

FIG. 3 is a perspective view of a tip portion of a screw shaft provided to the electric brake device.

FIG. 4 is a plan view of a third gear provided to the electric brake device.

FIG. 5 is a perspective view of a load sensor provided to the electric brake device.

FIG. 6 is a plan view of the load sensor that is seen from a rear side in an axial direction.

FIG. 7 is a partial cross-sectional view of a portion around terminals of the electric brake device.

FIG. 8 is a view illustrating a first step of assembly of a housing to a case in a manufacturing process of the electric brake device.

FIG. 9 is a view illustrating a state of a second step of the same assembly.

FIG. 10 is a view illustrating a state of a third step of the same assembly.

FIG. 11 is a plan view of a load sensor in a first modified example of the electric brake device.

FIG. 12 is a plan view of a load sensor in a second modified example of the electric brake device.

FIG. 13 is a cross-sectional view of a case-side terminal in a third modified example of the electric brake device and surroundings thereof.

FIG. 14 is a perspective view of a case-side terminal in a fourth modified example of the electric brake device.

FIG. 15 is a perspective view of a load sensor in a fifth modified example of the electric brake device.

FIG. 16 is a plan view of a load sensor in a sixth modified example of the electric brake device.

### DESCRIPTION OF EMBODIMENTS

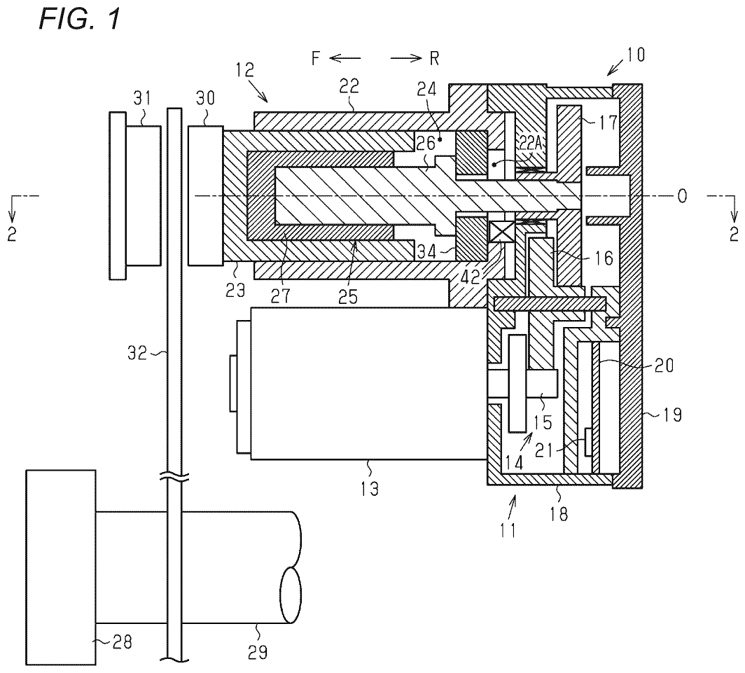

Hereinafter, a description will be made on an embodiment that embodies an electric brake device with reference to FIG. 1 to FIG. 10.

### Configuration of Electric Brake Device

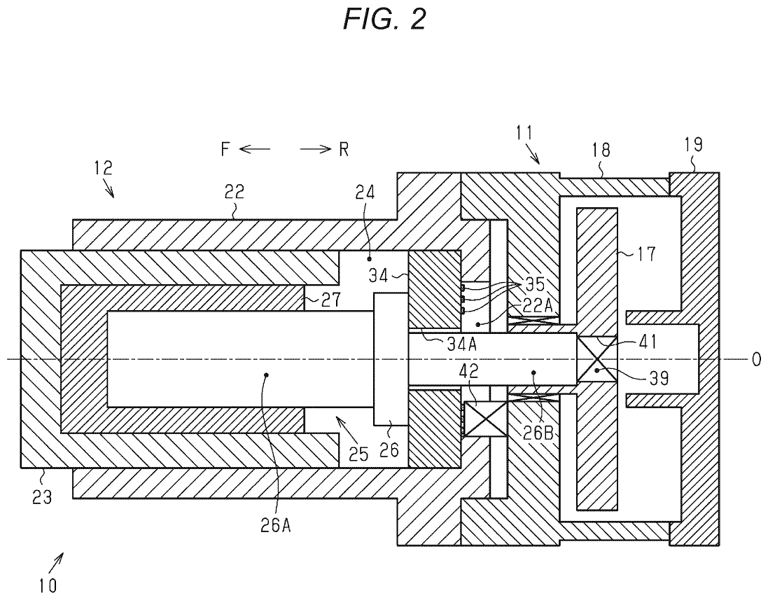

First, a description will be made on a configuration of an electric brake device 10 in this embodiment with reference to FIG. 1 and FIG. 2. FIG. 1 illustrates a cross-sectional structure of the electric brake device 10 and peripheral components thereof. FIG. 2 is a cross-sectional view of the electric brake device 10 that is taken along line 2-2 in FIG. 1. The electric brake device 10 has a drive section 11 and a caliper section 12.

The drive section 11 has an electric motor 13 and a transmission mechanism 14. The transmission mechanism 14 is a mechanism that reduces a speed of rotation of the electric motor 13 and then transmits the rotation thereof. In this embodiment, a reduction gear mechanism that has a first gear 15 coupled to the electric motor 13, a second gear 16 meshing with the first gear 15, and a third gear 17 meshing with the second gear 16 is adopted as the transmission mechanism 14. In this embodiment, the third gear 17 of such a transmission mechanism 14 corresponds to a rotary member that is rotated by the electric motor 13. The electric motor 13 is assembled to a case 18 that is a casing for the drive section 11. In addition, a cover 19 is assembled to the case 18. Then, a storage space for the transmission mechanism 14 is formed by the case 18 and the cover 19. Each of the first gear 15, the second gear 16, and the third gear 17 that constitute the transmission mechanism 14 is rotatably held in the case 18. The drive section 11 also includes a circuit board 20 that includes a CPU 21 as a control section for controlling output of the electric motor 13. In an isolated state from the transmission mechanism 14, the circuit board 20 is stored in the storage space formed by the case 18 and the cover 19.

Meanwhile, the caliper section 12 has a housing 22, a piston 23, and a linear motion conversion mechanism 25. The housing 22 as a casing for the caliper section 12 is assembled to the case 18. The housing 22 has a cylinder 24 in a shape of a circular tube. The cylinder 24 holds the piston 23 to be slidable. The linear motion conversion mechanism 25 is a mechanism that has a rotational section and a linear motion section and converts rotary motion of the rotational section into linear motion of the linear motion section. In a case of this embodiment, a feed screw mechanism that has a screw shaft 26 as the rotational section and a nut 27 as the linear motion section is adopted as the linear motion conversion mechanism 25. The screw shaft 26 is arranged to be coaxial with a rotation axis O of the third gear 17 in the transmission mechanism 14. In addition, the screw shaft 26 and the third gear 17 mesh with each other mechanically and directly. In this way, the screw shaft 26 and the third gear 17 are coupled to each other in a manner to be able to transmit the rotary motion. Meanwhile, the nut 27 is coupled to the piston 23 in a manner to be able to transmit the linear motion thereto. Here, the linear motion conversion mechanism 25 is assembled to the electric brake device 10 such that a rotation axis of the screw shaft 26 is located on the rotation axis O of the third gear 17. The screw shaft 26 of such a linear motion conversion mechanism 25 is rotatably held by the nut 27. The nut 27 is held in the cylinder 24 via the piston 23. Thus, the screw shaft 26 of the linear motion conversion mechanism 25 is rotatably held in the housing 22 via the nut 27 and the piston 23.

The electric brake device 10 is arranged on a side of a wheel 28 of an automobile. A wheel shaft 29 as a rotational shaft of the wheel 28 is installed such that a brake disc 32 sandwiched between two friction members 30, 31 rotates as one unit. When the piston 23 presses one (the friction member 30) of the two friction members 30, 31, the two friction members 30, 31 are operated in an interlocking manner to reduce a distance therebetween.

Such an electric brake device 10 generates a braking force on the wheel 28 in the following mode. The rotation of the electric motor 13 is decelerated via the first gear 15, the second gear 16, and the third gear 17 of the transmission mechanism 14 and is then transmitted to the screw shaft 26 of the linear motion conversion mechanism 25. In the linear motion conversion mechanism 25, the rotary motion of the screw shaft 26 is converted into linear motion of the nut 27. Then, in conjunction with the linear motion, the friction members 30, 31 press the brake disc 32 to generate the braking force on the wheel 28. In this embodiment, the brake disc 32 corresponds to a rotary body.

In the following description, in the electric brake device 10, a direction that is parallel to the rotation axis O of the screw shaft 26 will be described as an axial direction. Furthermore, in the axial direction, when seen from the third gear 17, a side on which the nut 27 as a linear motion element of the linear motion conversion mechanism 25 is located will be described as a front side F in the axial direction, and an opposite side thereof will be described as a rear side R in the axial direction.

Here, as illustrated in FIG. 2, the screw shaft 26 of the linear motion conversion mechanism 25 has a screw section 26A, which is provided with a screw meshing with the nut 27. The screw shaft 26 also has a shaft section 26B that extends toward the rear side R in the axial direction from the screw section 26A. In the housing 22, a shaft hole 22A, through which the shaft section 26B is inserted, is provided to a portion that abuts a wall surface on the rear side R in the axial direction of the cylinder 24. Then, the screw shaft 26 is installed in the housing 22 in a state where the screw section 26A is stored in the cylinder 24 and the screw section 26A protrudes to the rear side R in the axial direction through the shaft hole 22A.

### Coupling Structure of Screw Shaft and Third Gear

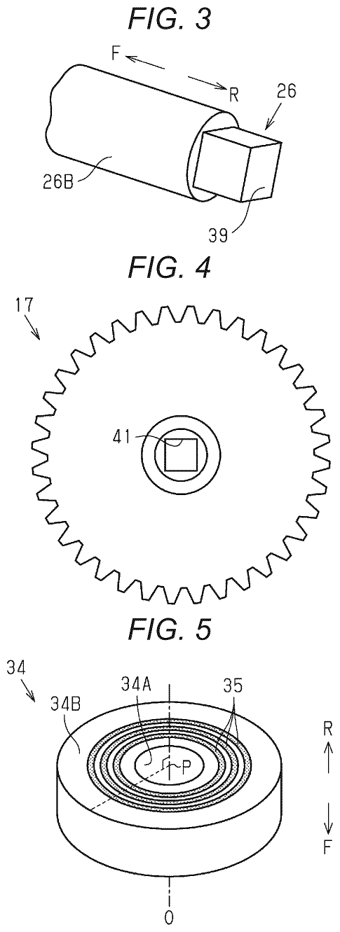

Next, a description will be made on a coupling structure of the screw shaft 26 and the third gear 17 with reference to FIG. 3 and FIG. 4. FIG. 3 illustrates a perspective structure of an end portion on the rear side R in the axial direction of the screw shaft 26. FIG. 4 illustrates a planar structure of the third gear 17 that is seen from the front side F in the axial direction.

As described above, the screw shaft 26 of the linear motion conversion mechanism 25 is coupled to the third gear 17 of the transmission mechanism 14 in the manner to be able to transmit the rotary motion. As illustrated in FIG. 3, the screw shaft 26 has an engagement convex section 39 having a square columnar shape in the end portion on the rear side R in the axial direction of the shaft section 26B. Meanwhile, as illustrated in FIG. 4, the third gear 17 has, at a center thereof, an engagement concave section 41 as a square-shaped hole with which the engagement convex section 39 of the screw shaft 26 can be engaged. The screw shaft 26 and the third gear 17 are assembled to the electric brake device 10 in a state where the engagement convex section 39 is engaged with the engagement concave section 41. The third gear 17 and the screw shaft 26 mesh with each other mechanically and directly due to the engagement between these engagement convex section 39 and engagement concave section 41.

### Structures of Load Sensor and Terminal Thereof

As illustrated in FIG. 2, the electric brake device 10 includes a load sensor 34 that is a sensor for detecting a pressing load applied to the brake disc 32 by the friction members 30, 31. The load sensor 34 is stored in the housing 22. In the cylinder 24, the load sensor 34 is arranged in a portion on the rear side R of the screw section 26A in the axial direction. When the friction members 30, 31 press the brake disc 32, a reaction force thereof is applied to the piston 23. The reaction force applied to the piston 23 is transmitted to the screw shaft 26 via the nut 27. The load sensor 34 is arranged to receive the reaction force that is transmitted to the screw shaft 26. In addition, the load sensor 34 is configured to output, as a pressing load detection signal, a signal that corresponds to the reaction force received from the screw shaft 26.

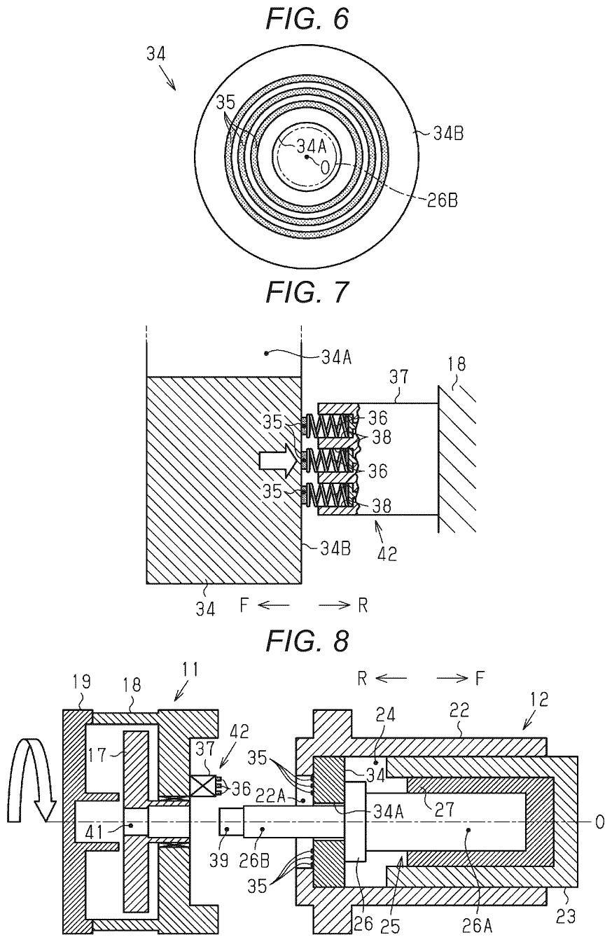

FIG. 5 illustrates a perspective structure of the load sensor 34. In addition, FIG. 6 illustrates a planar structure of the load sensor 34 that is seen from the rear side R in the axial direction. The load sensor 34 has a toroidal columnar shape having a through-hole 34A in a columnar shape, through which the shaft section 26B of the screw shaft 26 is inserted. In the following description, in the load sensor 34 in an assembled state to the electric brake device 10, an annular surface located on the rear side R in the axial direction will be described as a bottom surface 34B of the load sensor 34. The load sensor 34 is assembled to the housing 22 in a state where a center axis thereof is located on the rotation axis O of the screw shaft 26, the shaft section 26B of which has been inserted through the through-hole 34A. That is, the load sensor 34 is assembled to the housing 22 such that the bottom surface 34B thereof is located on a plane orthogonal to the rotation axis O of the screw shaft 26.

The bottom surface 34B of the load sensor 34 is provided with three first terminals 35 for connecting an electric circuit in the sensor to the outside. The load sensor 34 outputs a signal corresponding to the detected pressing load to the first terminals 35. In this embodiment, each of such first terminals 35 corresponds to an output section. Each of the first terminals 35 is an electrode plate having an annular shape that is centered at an intersection point P between the rotation axis O and the plane orthogonal to the rotation axis O on which the bottom surface 34B is located. The three first terminals 35 are arranged concentrically. That is, the first terminals 35 are formed in the annular shapes arranged to be centered on the rotation axis O. The three first terminals 35 are a positive power terminal, an output terminal for the detection signal, and a power terminal on a ground side, respectively.

As illustrated in FIG. 7, a terminal block 37 is installed in a portion of the case 18 that opposes the bottom surface 34B of the load sensor 34. Three terminal holes 38 are arranged side by side in the terminal block 37. Then, a second terminal 36 is stored in each of the terminal holes 38. Each of the second terminals 36 is configured by a coil spring whose expansion/compression direction is set in a parallel direction to the rotation axis O. Each of the second terminals 36 is connected to the circuit board 20 through wiring. Each of the second terminals 36 is installed in the electric brake device 10 in a state where an end thereof on the front side F in the axial direction is in contact with the respective first terminals 35 of the load sensor 34 and in a state of being elastically compressed between the load sensor 34 and the case 18. That is, each of the second terminals 36 is an elastic section that is elastically compressed in a state where the load sensor 34 and the case 18 are assembled. In the following description, the terminal block 37 in a state where the second terminal 36 is stored in the respective terminal holes 38 will be described as a case-side terminal section 42.

The first terminals 35 and the second terminals 36 are electrically connected to each other through contact, respectively. In this way, the first terminal 35 as the output section, from which the load sensor 34 outputs the detection signal, is electrically connected to the circuit board 20 provided with the CPU 21 as the control section. That is, in this embodiment, the second terminals 36 each correspond to a connection section as a portion that connects each of the first terminals 35 as the output section to the CPU 21 as the control section.

### Assembly of Case and Housing

In the manufacture of the electric brake device 10, components of the caliper section 12 are assembled, that is, the load sensor 34, the linear motion conversion mechanism 25, and the piston 23 are assembled to the housing 22. Then, the housing 22 and the case 18 are assembled such that the housing 22, to which the components have been assembled, is fixed to the case 18.

A description will be made on a procedure for assembling the housing 22 to the case 18 with reference to FIG. 8 to FIG. 10. In the assembly, the components of the caliper section 12 are assembled in advance, and the transmission mechanism 14 and the case-side terminal section 42 are assembled to the case 18 in advance. The electric motor 13, the cover 19, and the circuit board 20 may be assembled to the case 18 either before or after the assembly of the caliper section 12.

In addition, in this embodiment, assembly work is performed in a state where the caliper section 12 is fixed and the case 18 is held as follows. That is, the above state is a state where the rotation axis O of the third gear 17 is located on the rotation axis O of the screw shaft 26 is maintained, and a state where the case 18 can rotate about the rotation axis O and the case 18 can be moved linearly in the axial direction.

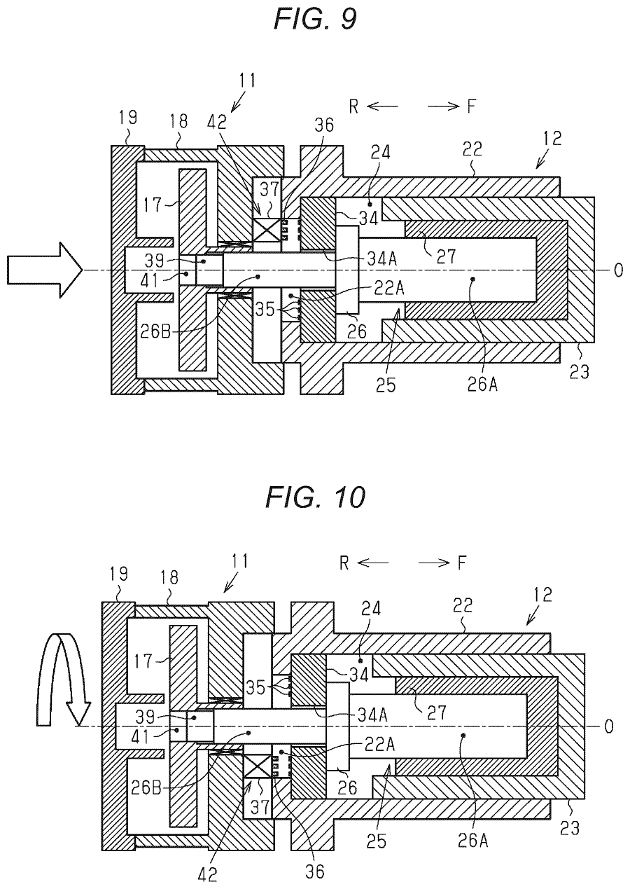

In the assembly of the case 18 and the housing 22, first, as illustrated in FIG. 8, the case 18 is moved in the axial direction until a distance between the engagement convex section 39 of the screw shaft 26 and the engagement concave section 41 is reduced to some extent. Then, the engagement convex section 39 and the engagement concave section 41 are phased. That is, the case 18 is rotated such that a rotational phase of the engagement convex section 39 about the rotation axis O becomes a phase in which the engagement convex section 39 can be inserted in the engagement concave section 41. Next, as illustrated in FIG. 9, the case 18 is moved to the front side F in the axial direction until a part of the engagement convex section 39 is inserted in the engagement concave section 41. Then, as illustrated in FIG. 10, the case 18 is rotated about the rotation axis O again to phase the case 18 with the housing 22. Thereafter, the case 18 is moved to a position at which the case 18 abuts the housing 22, and then fixing work of the case 18 and the housing 22 is performed.

Here, at least one of the engagement convex section 39 and the engagement concave section 41 may be chamfered. Since phase shift between the engagement convex section 39 and the engagement concave section 41 can be absorbed by chamfering, phasing is facilitated.

### Operational Effects of Embodiment

The first terminals 35, which are installed on the bottom surface 34B of the load sensor 34 in the electric brake device 10 of this embodiment, are respectively in contact with the second terminals 36 installed in the case 18. Then, the first terminals 35 and the second terminals 36 are electrically connected to each other through the contact, respectively. Each of the first terminals 35 has the annular shape whose center is located on the rotation axis O of the screw shaft 26. In this way, even when the rotational phase of the load sensor 34 about the rotation axis O is changed, the electrical connection between each of the first terminals 35 and each of the second terminals 36 is maintained. Thus, in the assembly of the load sensor 34 to the housing 22, phasing of the load sensor 34 is not necessary. Therefore, the assembly work of the load sensor 34 to the housing 22 is facilitated, and thus the assembly work of the caliper section 12 is facilitated.

In the electric brake device 10 of this embodiment, since each of the second terminals 36 is brought into contact with each of the first terminals 35 in the planar shape that is located on the plane orthogonal to the rotation axis O, the first terminals 35 and the second terminals 36 are electrically connected, respectively. In such an electric brake device 10, interference between each of the first terminals 35 and each of the second terminals 36 does not occur even when the case 18 and the housing 22 are rotated relative to each other about the rotation axis O in the state where the engagement convex section 39 of the screw shaft 26 is partially or entirely engaged with the engagement concave section 41 of the third gear 17. Accordingly, due to the relative rotation between the case 18 and the housing 22, it is possible to phase the engagement convex section 39 of the screw shaft 26 with the engagement concave section 41 of the third gear 17. Therefore, the assembly work of the case 18 and the housing 22 is also facilitated.

In the electric brake device 10 of this embodiment, each of the second terminals 36 is configured by the coil spring. Then, the second terminals 36 are installed in the state of being elastically compressed between the load sensor 34 and the case 18. Thus, even when a distance between the load sensor 34 and the terminal block 37 is slightly changed, the contact of each of the second terminals 36 with each of the first terminals 35 can be maintained. Therefore, the electrical connection between the first terminals 35 and the second terminals 36 is less likely to be cut off when distortion occurs to the housing 22 or the like during generation of the braking force. In addition, since a tolerance of the distance between the load sensor 34 and the terminal block 37, within which the first terminals 35 and the second terminals 36 can be electrically connected, is increased, it is possible to increase a dimensional tolerance and an assembly tolerance of each of the components of the electric brake device 10.

### Other Embodiments

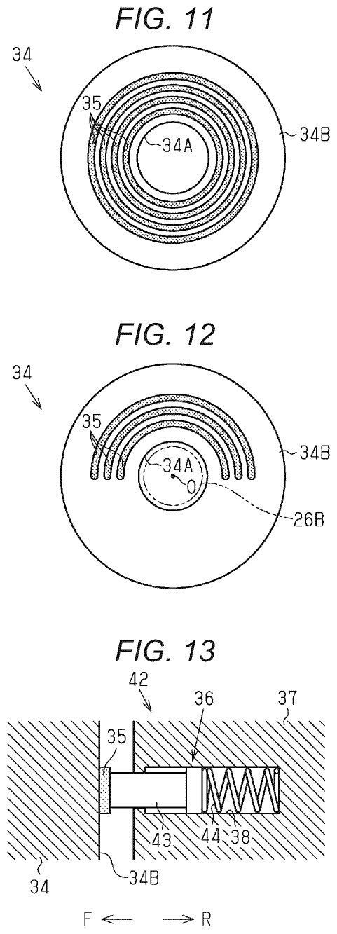

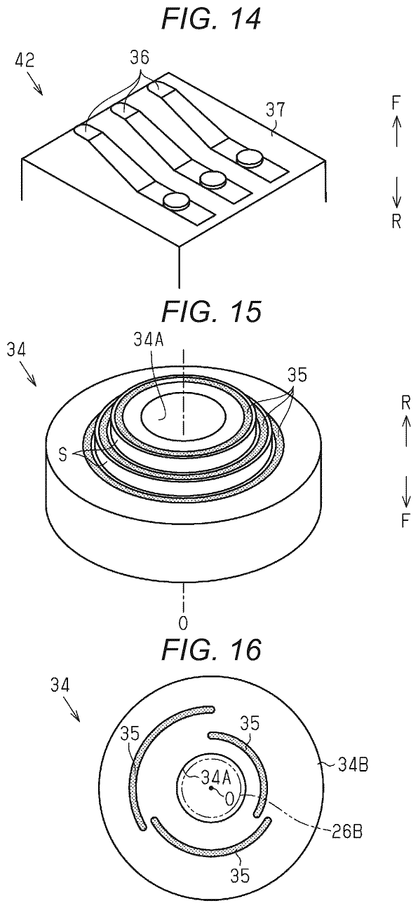

This embodiment can be modified and implemented as follows. This embodiment and each of the following modified examples can be implemented in combination with each other unless technically contradictory.
The numbers of the first terminals 35 and the second terminals 36 may be changed appropriately. FIG. 11 illustrates a configuration example of the load sensor 34 in which the four first terminals 35 are installed.
As exemplified in FIG. 12, the first terminals 35 may each have an arc shape. Also, in such a case, it is possible to expand a range of the allowable rotational phase of the load sensor 34 during the assembly to the housing 22. Therefore, even when the first terminals 35 each have the arc shape, the assembly work of the caliper section 12 is facilitated.
As illustrated in FIG. 13, the second terminal 36 may be configured by a contactor 43 that contacts the first terminal 35 and a spring 44 that urges the contactor 43. In a case of FIG. 13, the spring 44 is installed in the terminal hole 38 while being compressed. Then, the contactor 43 is urged to the front side F in the axial direction by the spring 44. In this case, the contactor 43 as a contact section and the spring 44 as an elastic section constitute the second terminal 36 as the connection section.
A spring other than the coil spring may be used as the spring for the second terminal 36. FIG. 14 illustrates a configuration example of the second terminals 36, each of which uses a leaf spring.
A terminal that does not have a spring may be used as the second terminal 36. That is, the contact section may be configured not to have the elastic section that is elastically compressed in the state where the load sensor 34 and the case 18 are assembled.
As illustrated in FIG. 15, a step S may be provided between installation surfaces of two each of the adjacent first terminals 35. That is, it may be configured that at least one of plural contacted sections is arranged at a different position from those of the other contacted sections in an extending direction of the rotation axis O. In the case where the two adjacent first terminals 35 are installed on the same plane, the second terminal 36 possibly contacts the different first terminal 35 from the first terminal 35 that the second terminal 36 originally intends to contact. When the step S is provided between the installation surfaces of two each of the first terminals 35 as illustrated in FIG. 15, the second terminal 36 is less likely to make such false contact.
As illustrated in FIG. 16, the plural first terminals 35, each of which has the arc shape, may be arranged at positions shifted from each other around the rotation axis O. Also, in such a case, the false contact by the second terminal 36 as described above is less likely to occur.
The load sensor 34 and a group of the first terminals 35 may be separate components. For example, the first terminals 35 may be installed in the case 18, and the load sensor 34 and each of the first terminals 35 may be electrically connected by wiring.
The first terminals 35 may be installed in the case 18, and the second terminals 36 may be installed on the load sensor 34. That is, the output section that is stored in the housing 22 may have the contact section, and the connection section that is stored in the case 18 may have the contacted section.
The caliper section 12 may be assembled to the case 18 in a state where the case 18 is fixed and the caliper section 12 is held to be rotatable and movable in the axial direction.

Alternatively, such assembly may be performed in a state where one of the case 18 and the caliper section 12 is held to be rotatable and the other is held to be movable in the axial direction. Further alternatively, such assembly may be performed in a state where both of the case 18 and the caliper section 12 are held to be rotatable and movable in the axial direction.
The linear motion conversion mechanism 25 may be configured that the nut 27 serves as a rotational element and the screw shaft 26 serves as a linear motion element. In such a case, the engagement convex section 39 is provided to the nut 27 as the rotational element.
The engagement concave section 41 may be provided to the rotational element of the linear motion conversion mechanism 25, and the engagement convex section 39 may be provided to the third gear 17.
The engagement convex section 39 and the engagement concave section 41 may each have a shape other than the square columnar shape as long as having a shape capable of transmitting the rotary motion through the engagement.
The number of the gears in the transmission mechanism 14 may be changed. In addition, a mechanism other than the reduction gear mechanism, such as a winding transmission mechanism, may be adopted as the transmission mechanism 14.
A drum-shaped rotary body may be used as the rotary body that is pressed by the friction members 30, 31.

1. An electric brake device that transmits rotation of an electric motor to a linear motion conversion mechanism by a transmission mechanism, converts rotary motion transmitted by the transmission mechanism from rotary motion of a rotational section into linear motion of a linear motion section in the linear motion conversion mechanism, presses a friction member that interlocks with the linear motion of the linear motion section against a rotary body that rotates together with a wheel, and thereby generates a braking force on the wheel, the electric brake device comprising:
a sensor that detects a pressing load of the friction member against the rotary body and outputs a signal corresponding to the detected pressing load to an output section;
a connection section as a portion that electrically connects the output section to a control section controlling the electric brake device;
a housing that stores the sensor, the output section, and the linear motion conversion mechanism; and
a case that stores the transmission mechanism, the control section, and the connection section, and
when the housing and the case are assembled, the rotational section of the linear motion conversion mechanism and the transmission mechanism mechanically meshing with each other, wherein
the rotational section is arranged to be coaxial with a rotation axis of the transmission mechanism that directly meshes with the rotational section,
one of the output section and the connection section has a contacted section that is formed in an annular shape or an arc shape and is arranged around the rotation axis, and
the other of the output section and the connection section has a contact section that electrically connects the output section and the connection section by contacting the contacted section in a state where the housing and the case are assembled.

2. The electric brake device according to claim 1, wherein the contact section has an elastic section that is elastically compressed in a state where the sensor and the case are assembled.

3. The electric brake device according to claim 1, wherein one of the output section and the connection section has a plurality of the contacted sections, and at least one of the plurality of the contacted sections is located at a different position from those of the other contact sections in a direction of the rotation axis.
